(19) United States
(12) Patent Application Publication
(10) Pub. No.: US 2016/0233601 A1
(43) Pub. Date: Aug. 11, 2016

(54) HEADER, RECEPTACLE, CONNECTOR, AND METHOD OF MANUFACTURING THE HEADER

(71) Applicant: FUJITSU COMPONENT LIMITED, Tokyo (JP)

(72) Inventors: Yayoi Tokuhara, Tokyo (JP); Takahiro Kondo, Tokyo (JP)

(21) Appl. No.: 15/132,364

(22) Filed: Apr. 19, 2016

Related U.S. Application Data
(62) Division of application No. 13/932,404, filed on Jul. 1, 2013, now Pat. No. 9,343,834.

(30) Foreign Application Priority Data
Jul. 26, 2012 (JP) 2012-166235

(51) Int. Cl. H01R 13/04; H01R 12/72; H01R 13/11

(52) U.S. Cl. CPC H01R 13/04; H01R 13/11; H01R 12/724

(57) ABSTRACT

A disclosed header connectable to a receptacle includes a first contact including a pair of first plate portions, which are electrically conductive and are separated by an interval, and a plate-like conductive member which is conductive and is accommodated between the pair of first plate portions.

### CROSS-REFERENCE TO RELATED APPLICATIONS

This patent application is a divisional application of and claims the benefit of priority under 35 U.S.C. 120 to the patent application Ser. No. 13/932,404 filed on Jul. 1, 2013, which was based upon and claims the benefit of priority of Japanese Patent Application No. 2012-166235 filed on Jul. 26, 2012, the entire contents of which are incorporated herein by reference.

### BACKGROUND OF THE INVENTION

1. Field of the Invention

The present invention relates to a header (a plug), a receptacle (a jack), a connector, and a method of manufacturing the header.

2. Description of the Related Art

A connector including a power source line, a grounding line, or a signal line is used to electrically connect or disconnect electric apparatuses, wiring boards, or the like. Such an example of the connector is disclosed in, for example, Japanese National Publication of International Patent Application No. 2004-500684.

### SUMMARY OF THE INVENTION

According to an aspect of the embodiments of the present invention, there is provided a header being connectable to a receptacle and including a first contact including a pair of first plate portions, which are electrically conductive and are separated by an interval, and a plate-like conductive member which is conductive and is accommodated between the pair of first plate portions.

Additional objects and advantages of the embodiments are set forth in part in the description which follows, and in part will become obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a perspective view schematically illustrating a connector of a first embodiment of the present invention;

FIG. 2 is a perspective view schematically illustrating a first contact and a blade of the embodiment;

FIG. 3 schematically illustrates semifinished products of the first contacts;

FIG. 4 schematically illustrates the first contact and the reel connected to the first contact;

FIG. 5 is a perspective view schematically illustrating a fitting and fixing structure where a first contact is fit into a first insulator of the embodiment;

FIG. 6 schematically illustrates semifinished products of the first contacts;

FIG. 7 schematically illustrates an arrangement of through holes copper pads on a wiring board;

FIG. 8 is a perspective view schematically illustrating a first insulator of the embodiment;

FIG. 9 is a perspective view schematically illustrating a mode of the second insulator included in the receptacle of the embodiment;

FIG. 10 is a perspective view schematically illustrating an electric connection between the first contact, the blade, and the second contact;

FIG. 11 is a perspective view schematically illustrating an electric connection between the first contact, the blade, and the second contact;

FIG. 12 schematically illustrates electric connection between the first contact, the blade, and the second contact;

FIG. 13 is a perspective view schematically illustrating another mode of the first contact and the blade of the embodiment; and

FIG. 14 is a perspective view schematically illustrating a connection between the first contact, the blade and the second contact of the embodiment.

### DETAILED DESCRIPTION OF THE EMBODIMENTS

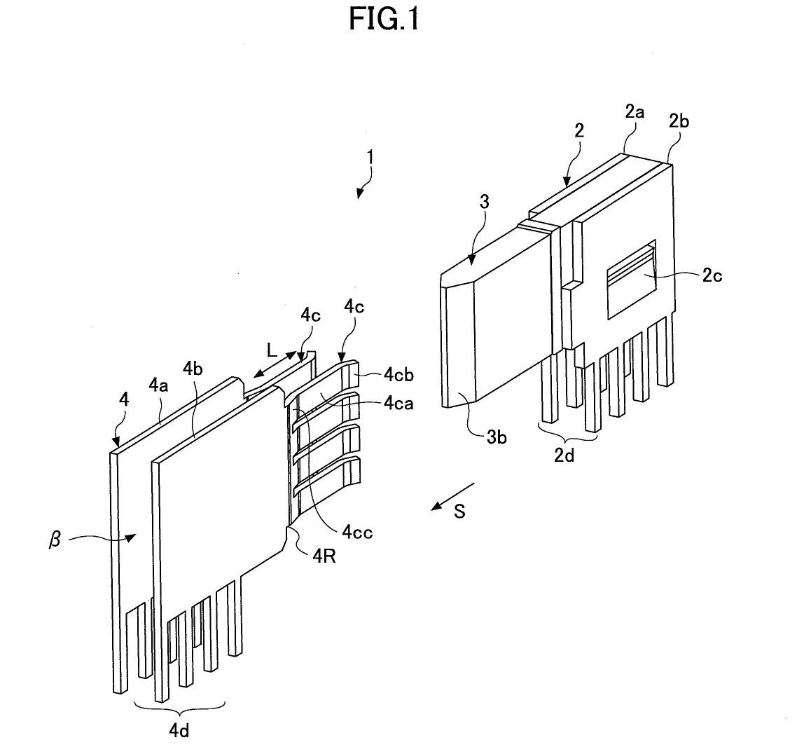

A description of embodiments of the present invention is given below, with reference to the FIG. 1 through FIG. 14. Where the same reference symbols are attached to the same parts, repeated description of the parts is omitted.

Referring to FIG. 1, a connector 1 of the embodiment includes a header, which includes a first contact 2 and a blade 3 (an example of a plate-like conductive member) accommodated in the first contact 2, and a receptacle, which corresponds to the header and includes a second contact 4. The first contact 2 is made of, for example, a plate-like conductive material suitably undergoing a press process, a bend process, or a cut process.

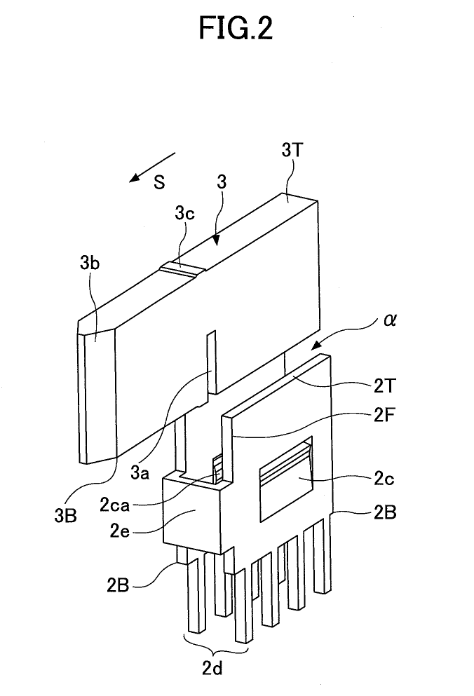

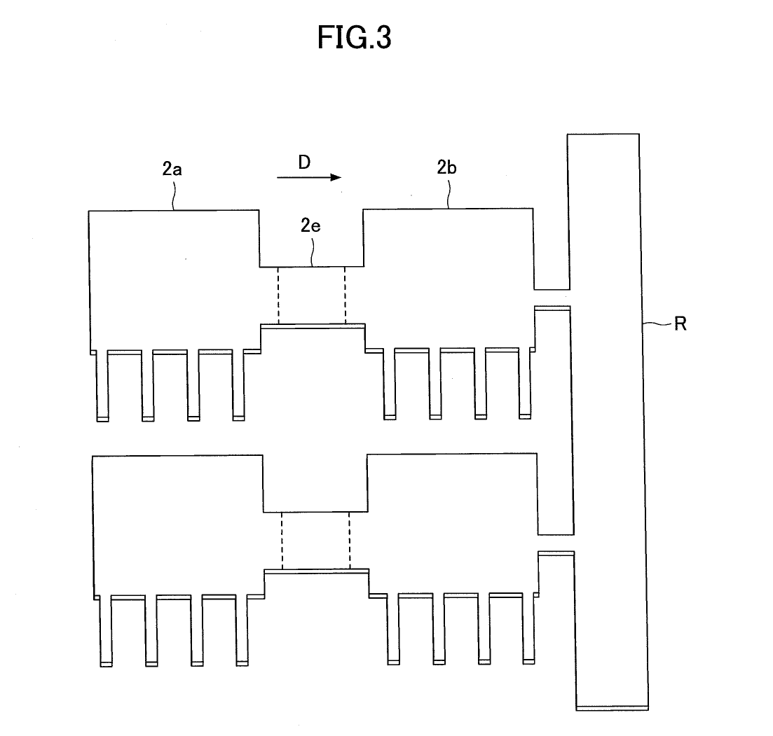

Referring to FIGS. 2 and 3, the first contact 2 includes a pair of first plate portions 2a and 2b, which are shaped like a rectangular and arranged in parallel. The blade 3 is accommodated in a space α shaped like a rectangular parallelepiped between the pair of first plate portions 2a and 2b. Each of the first plate portions 2a and 2b includes movable spring 2c (an example of a flexible portion), which have a contact point to contact the blade 3 at an end portion of the movable spring 2c, respectively. The movable spring 2c is tongue-shaped piece formed by cutting a part of the first plate portion 2a or 2b like the letter “U”. The contact point 2ca is formed by bending a base and an end portion the tongue-shaped piece so that the contact point 2ca protrude onto one side of the space α.

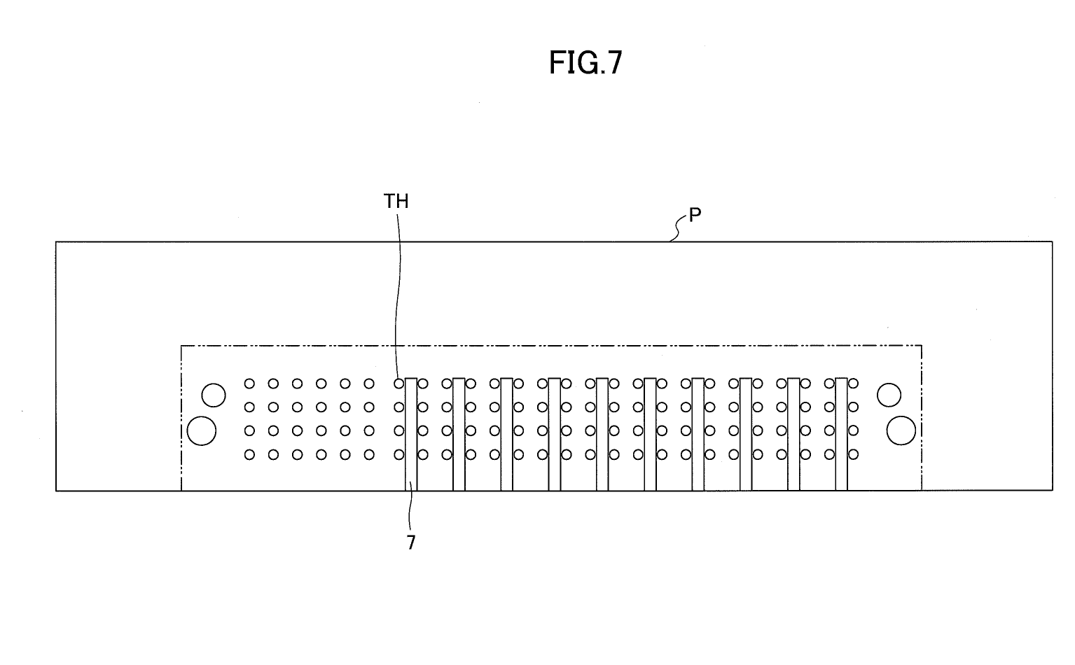

An edge portion 2B is provided in each of the first plate portions 2a and 2b. The edge portion 2B is positioned in a lower part of each first plate portion 2a and 2b as illustrated in FIG. 2. The edge portions 2B face a wiring board P illustrated in FIG. 7. A plurality of first terminals 2d is formed to protrude from the edge portion 2B. The first terminals 2d are formed so as to be inserted into through holes of the wiring board. Referring to FIG. 2, four first terminals 2d are formed in the edge portion 2B of the first plate portion 2a at even intervals, and the first terminals 2d are formed in the edge portion 2B of the first plate portion 2b at even intervals.

An edge portion 2F of each of the first plate portions 2a and 2b faces the second contact 4 in a connecting direction S which is a direction of connecting the first contact 2 with the second contact 4. The edge portions 2F are connected each other through a plate-like connecting portion 2e formed perpendicular to the connecting direction. The connecting portion 2e is shaped to extend between a position apart by predetermined lengths from the edge portion 2B of the first plate portion 2a and 2b and a position substantially at the center between the position apart by predetermined lengths from the edge portion 2B and edge portion 2T of the first plate portion 2a and 2b. The first plate portions 2a and 2b face the wiring board and are positioned at the base of the first terminals 2d. A plain surface of the connecting portion 2e is formed to protrude (offset) from the edge portion 2F of the first plate portions 2a and 2b toward the side of the second contact 4.

The blade 3 is made of a plate-like conductive member having conductivity equal to or substantially higher than a conductive material forming the first contact 2 and formed by, for example, press forming. Referring to FIG. 2, the blade 3 is longer than the first plate portions 2a and 2b in the connecting direction S. The thickness of the blade 3 is greater than the thickness of the first plate portions 2a and 2b, and is substantially the same as the interval between the first plate portions 2a and 2b. A part of the blade 3 is accommodated in the space α formed between the first plate portions 2a and 2b.

A cutout 3a to be fit into the connecting portion 2e of the blade 2 is formed in the blade 3. The cutout 3a is formed from an edge portion 3B facing the wiring board toward an edge portion 3T positioned on the opposite side to the wiring board. On the side of the blade 3 protruding from the first plate portions 2a and 2b, a wedge 3b is formed to smooth the connection between the blade 3 and the second contact 4. A raised portion (a bulge) 3c is formed on the edge portion 3T to protrude from the edge portion 3T.

FIG. 2 illustrates a condition where the cutout 3a of the blade 3 is not fit into the connecting portion 2e of the first contact 2. By moving the blade 3 onto the side of the first terminals 2d from the position illustrated in FIG. 2, the cutout 3a is fit into the connecting portion 2e. Thus, the blade 3 is mechanically fixed to the first contact 2. Further, the blade 3 contacts the contact point 2ca of the movable springs 2c. Thus, the first contact 2 is electrically connected with the blade 3.

Referring to FIG. 1, the second contact 4 includes a pair of second plate portions 4a and 4b arranged in parallel each other. The pair of the second plate portions 4a and 4b is made of, for example, a plate-like conductive material and is formed by a press process, a bend process, and a cut process. A space β between the second plate portions 4a and 4b is greater than the width of space α, and is shaped like a rectangular parallelepiped. Referring to FIG. 1, edge portions 4R are formed in each of the second plate portions 4a and 4b on the side facing the header. The pair of the second plate portions 4a and 4b includes pairs of movable springs (holding portions) 4c, where each movable springs extending from the edge portions 4R toward the header.

Four movable springs 4c are formed to protrude from the edge portion 4R of each second plate portion 4a and 4b. Referring to FIG. 1, each of the movable springs 4c includes a contact point 4ca forming a contact surface contacting the blade 3, and having a predetermined length L along the connecting direction S. A guide portion 4cb for guiding the wedge 3b of the blade 3 is formed in each of the contact points 4ca on the side facing the header. The interval of the pair of contact points 4ca is set to be slightly thinner than the thickness of the blade 3. An offset portion 4cc is formed in a border between the movable spring 4c and the edge portion 4R on each of the second plate 4a and 4b. The offset portions 4cc are provided to adjust a difference between the space β and the interval between the pair of contact points 4ca. Four pairs of offset portions 4cc protrude from the pair of the second plate portions 4a and 4b so as to reduce the interval between the offset portions 4cc facing each other toward ends of the offset portions 4cc. The ends of the offset portions 4cc are connected with the contact points 4ca. The above described length L of the contact 4ca is a distance from the offset portion 4cc to the guide portion 4cb. By adjusting the length L, a contact resistance between the first contact 2 and the second contact 4 is adjusted.

Four second terminals 4d protrude from each edge portion 4R of the second plate portions 4a and 4b. The second terminals 4d are formed so as to be inserted into a wiring board on the side of the receptacle.

A method of manufacturing the first contacts 2 is described. Referring to FIG. 3, a plurality of semifinished products of the first contacts 2 before a bend process are connected by a reel R. The reel R extends in a direction perpendicular to a longitudinal direction D, which is a direction where the first plate portion 2a, the connecting portion 2e and the first plate portion 2b are arranged in parallel. A shape illustrated in FIG. 3 is formed when a base material undergoes a punch process. Referring to FIG. 3, the reel R connects the first plate portions 2b.

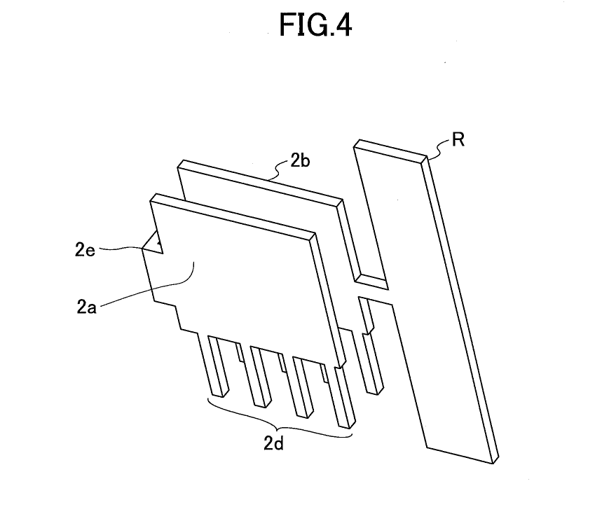

Then, the connecting portions 2e of the semifinished products is bent along fold lines indicated by broken lines in FIG. 3. Thus, the first contacts 2 before separating the first contacts 2 from the reel R are formed as illustrated in FIG. 4. A header includes the first contact 2, the blade 3, and a first insulator 5.

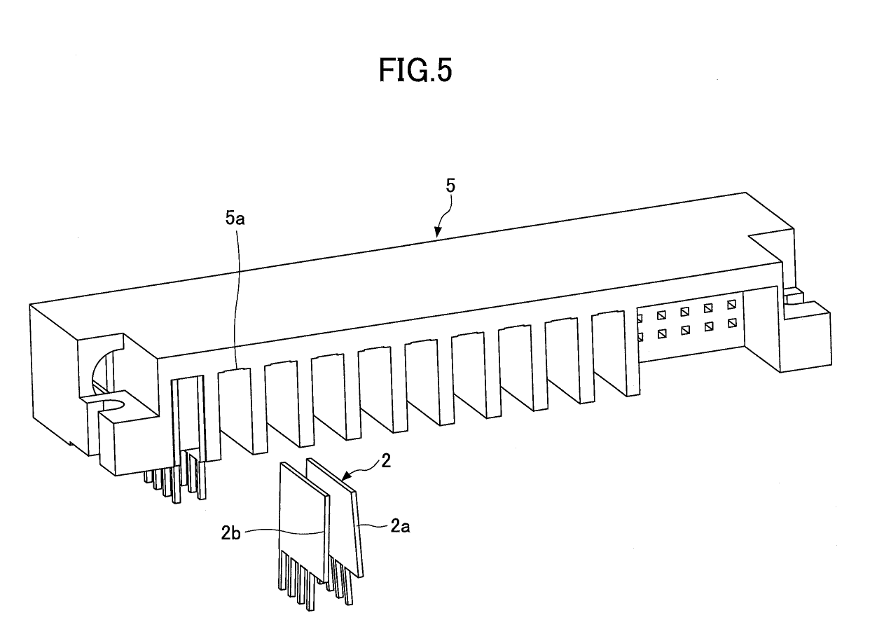

Referring to FIG. 5, the first insulator 5 forming a portion of the header has slots 5a for each accommodating and fixing the first contact 2 before the first insulators 5 are separated from the reel R. Four pairs of first terminals 2d are shaped so that the first terminals facing each other are separated to be broadened toward the ends in a width direction (a thickness direction of the first plate portions 2a and 2b). The contacts 2 are cut from the reel R after the wedges 3b of the blades 3 (not illustrated in FIG. 5) are inserted into the slots 5a so as to protrude onto the back side of FIG. 5. At this time, the raised portion 3c of the blade 3 is engaged with a recess formed inside the slot 5a, and the blades 3 are aligned in and fixed to the first insulator 5. The above described broadened shape of the first contacts 2, the slots 5c, and the recess corresponds to the raised portion 3c function to fit the first contacts 2 into the first insulator 5 and to fix the first contacts 2 to the first insulator 5.

By forming the first plate portions 2b to be connected to the reel R as illustrated in FIG. 4, each first plate portion 2b can be separated from the reel R, after the first contacts 2 is inserted into the first insulator 5 by holding the reel R extending perpendicular to a direction of inserting the first contact 2. By repeating the above processes the first contacts 2 are inserted into the corresponding slots 5a. Thus, the insertion of the first contacts 2 into the first insulator 5 becomes easy.

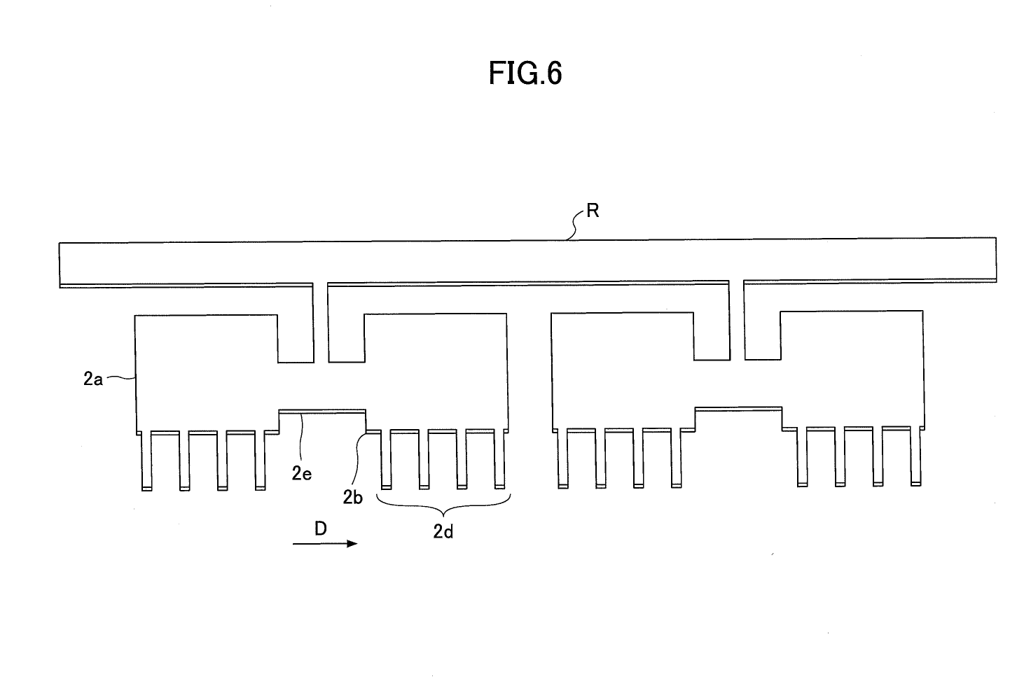

When inserting the first contacts 2 into the first insulator 5 without holding the reel R to facilitate the insertion, it is possible to connect the connecting portions 2e to the reel R as illustrated in FIG. 6. Referring to FIG. 6, the first plate portion 2a, the connecting portion 2e and the first plate portion 2b are arranged in the longitudinal directions D, which is a direction parallel to the direction to which the reel R extends. In this case, the connecting portions 2e before bending illustrated in FIG. 6 undergoes a bend process to form the first contact 2. Then, the first contacts 2 are cut from the reel R and inserted into the slots 5a by holding the first contacts 2.

An arrangement of through holes TH of a wiring substrate P, into which the first terminals 2d of the first contact 2 is inserted, is illustrated in FIG. 7. Referring to FIG. 7, a copper pad 7 is formed on the side of the wiring board P between through holes TH facing each other along a direction of arranging the four pairs of through holes TH. If the wiring board P is prepared as a part by a delivery destination, the above wiring board P may be previously prepared as a part forming the connector 1. This copper pad 7 is, for example, a conductive film coated on the wiring board P. After the plurality of first terminals 2d of the first contact 2 into which the blade 3 is accommodated are inserted into the through holes TH, the copper pad 7 contacts the edge portion 3B of the blade 3 so as to be electrically connected. Thus, a cross-sectional area through which electric current passes in the vicinity of a contact position between the first terminal 2d and the through hole TH of the wiring board P is increased.

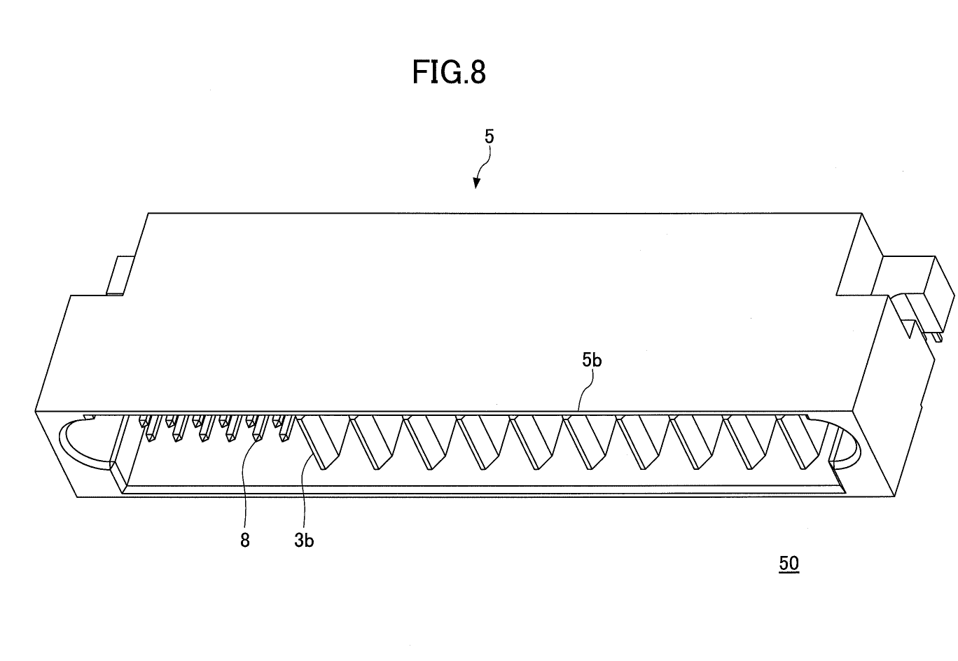

When the first contacts 2 accommodating the blades 3 are inserted into the first insulator 5 as illustrated in FIG. 5 viewed from the side of the slots 5a, the wedges 3b of the blades 3, which are inserted from a back surface side of the first insulator 5, are arranged in a width direction of the first insulator 5. Referring to FIG. 8 viewed from a side opposite to the side of the slots 5a, the arrangement of the wedges 3b of the blades 3 can be observed inside a fitting part 5b of the first insulator 5, through which a second insulator 6 is connected with the first insulator 5. Referring to FIG. 8, signal terminals 8 are arranged inside the fitting part 5b on the left side of the wedge 3b. The first contacts 2 and the blades 3 function as power terminals. As described, the first insulator 5, into which the first contacts 2 and the blades 3 are inserted, forms the header 50.

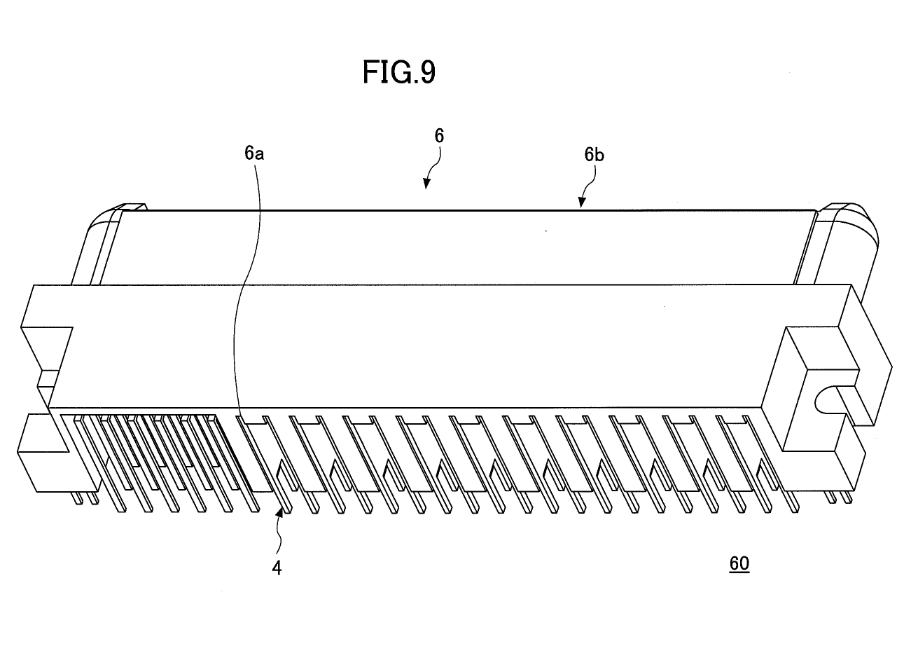

Referring to FIG. 9, the receptacle 60 to be connected to the header includes the second insulator 6 and the second contacts 4. The receptacle is formed by inserting the second contacts 4 illustrated in FIG. 1 into slots 6a of the second insulator. Referring to FIG. 1, the pair of second plate portions 4a and 4b forming the second contact 4 are independent from each other, unlike the first plate portion. Each of the second plate portions 4a and 4b is fit into and fixed to the corresponding slot 6a of the second insulator 6. The second insulator 6 has a to-be-fit part 6b to be fit into the fitting part 5b of the first insulator 5.

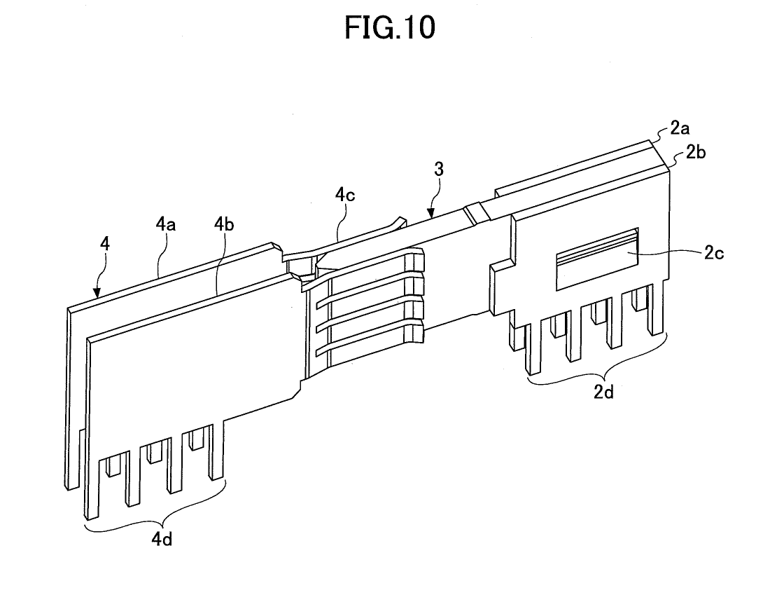

Within the embodiment, when the fitting part 5b of the first insulator 5 of the connector 1 is connected to the to-be-fit part 6b of the second insulator 6 of the receptacle, the blade 3 is sandwiched between the holding portions 4c of the second contact 4 in the thickness directions of the blade 3 as illustrated in FIG. 10 so that the blade 3 is electrically connected to the second contact 4. Said differently, the first terminals 2d are electrically connected to the second terminals 4d.

Since the blade 3 accommodated between the first plate portions 2a and 2b of the first contact 2 is thicker than the interval of the first plate portions 2a and 2b, which form the first contact 2, the cross-sectional area contributing passage of an electric current through an energizing path between first terminals 2d of the first contact 2 and second terminals 4d of the second contact 4 can be increased. Said differently, a resistance value of a part contributing to the passage of an electric current in the connector 1 is reduced. Therefore, it is possible to increase the value of an allowable electric current through the connector 1, and to restrict a temperature increment.

In the connector 1 of the embodiment, the first contact 2 is mechanically fixed to the blade 3 by fixing the cutout 3a into the connecting portion 2e. On the other hand, electrical connection between the first contact 2 and the blade 3 is secured by a contact between the side surface of the blade 3 and the movable spring 2c. Therefore, dimension tolerance in the cutout 3a and the connecting portion 2e can be relieved. Further, dimension tolerance in the thickness of the blade 3 and the space α between the first plate portions 2a and 2b is relieved.

Further, by providing the copper pad 7 contacting the blade 3 on the wiring board P, the cross-sectional area through which electric current passes in the vicinity of the contact position between the first terminals 2d and the through holes TH of the wiring board P is increased. Therefore, the temperature is restricted from increasing.

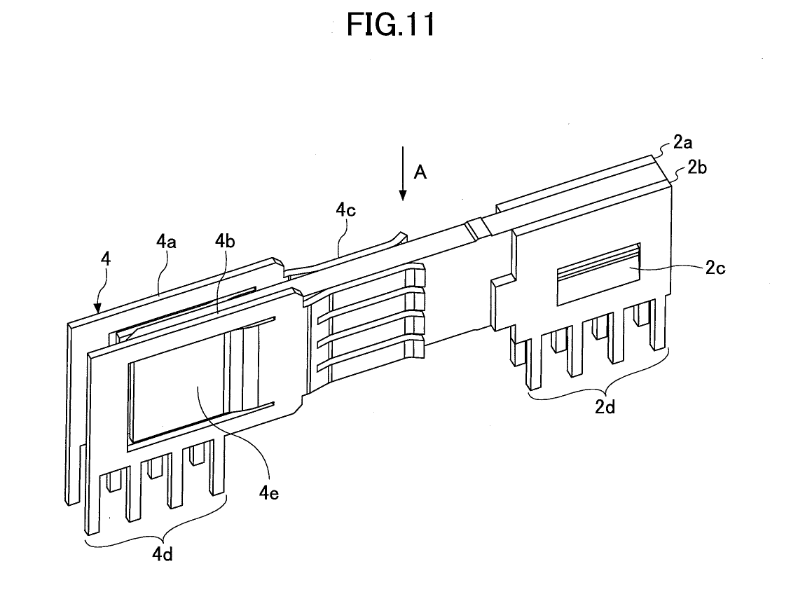

In addition to the structure illustrated in FIG. 10, movable springs 4e can be added to the second plate portions 4a and 4b as illustrated in FIG. 11. The movable springs (an example of an other holding portions) 4e are formed by cutting the second plate portions 4a and 4b in a shape of the letter “U” (a tongue-shaped piece), whose open end is on a side opposite to the holding portions 4c in the second contact 4. Further, the blade 3 is extended in the connecting direction to reach the movable springs 4e.

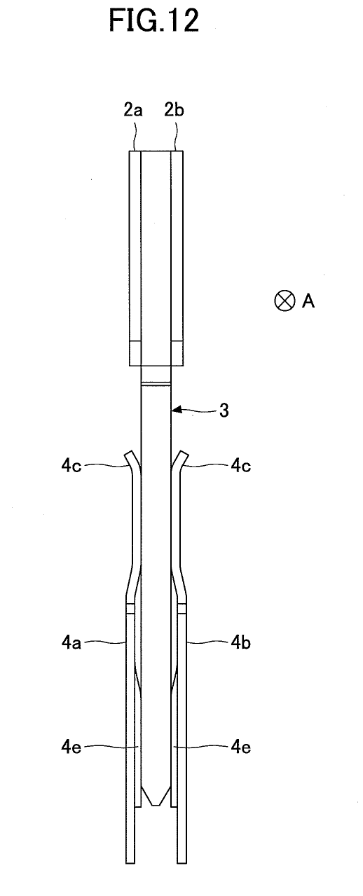

Then, referring to FIG. 12 viewed in a direction A in FIG. 11, an electric contact area between the blade 3 and the second contact 4 is increased. Therefore, electric connection is further ensured.

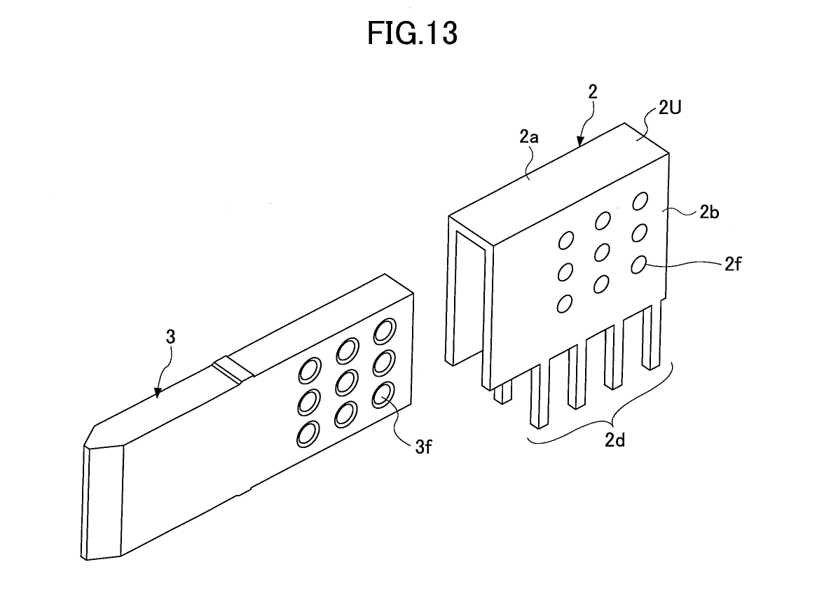

Meanwhile, instead of using the cutout illustrated in FIG. 2, the first contact 2 may contact the blade 3 as illustrated in FIG. 13. Referring to FIG. 13, the first plate portion 2a is connected to the first plate portion 2b by a top face 2U.

Further, the inner walls of the first plate portions 2a and 2b have protrusions 2f protruding inwardly so as to face each other. For example, the protrusions 2f are formed in a plurality of rows and a plurality of columns. Recesses 3f each of which corresponds to one of the protrusions 2f are formed on side surfaces of the blade 3. For example, the recesses 3f are formed in a plurality of rows and a plurality of columns.

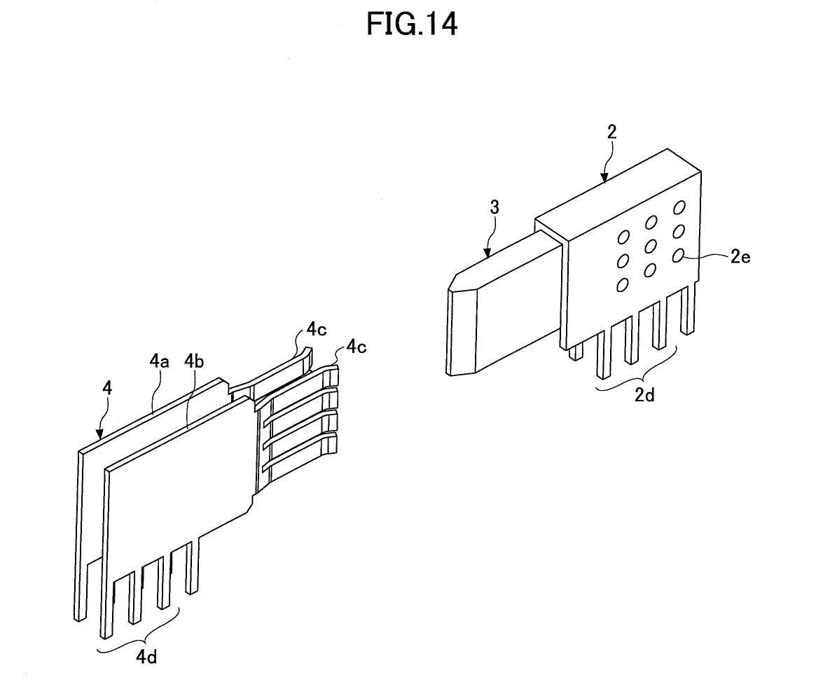

Each of the protrusions 2f can fit into the corresponding recess 3f, and the blade 3 can be fit into the first contact 2 as illustrated in FIG. 14. In this case, the blade 3 is mechanically fixed to and electrically connected with the first contact 2 by the protrusions 2f and the recesses 3f.

For example, within the embodiment, the first terminal 2d and second terminal 4d are connected to the wiring board by using through holes. However, the through holes on the wiring board may be changed to pads, and the first and second terminals may be changed to contact points. In this case, the contact points may be joined to the pad by soldering.

As described, within the embodiment, movable springs 4c in each of the first plate portions 2a and 2b are separated into a plural springs as illustrated in FIG. 1. The reason why using such springs is to reduce a force applied in a connection work where the blade 3 is wedged between the pairs of movable springs 4c against a friction force caused by contact between the blade 3 and the pairs of movable springs 4c. If it is not important to reduce the force, separating the movable springs 4c in each of the first plate portions 2a and 2b is not necessary.

Within the embodiment, the copper pads 7 are provided in the header. However, copper pads 7 may be provided on the wiring board of the receptacle.

According to the connector of the embodiment, the cross-sectional area through which electric current passes in the electric connection is increased to reduce a resistance value. Therefore, the rise in temperature can be prevented. The embodiment relates to a header forming a connector, a receptacle, and a method of manufacturing the header. Therefore, the embodiment is preferably used in connecting two wiring boards in order to supply electric power. The embodiment is applicable to electronic apparatuses for industrial use, for home use, for office use or the like. More particularly, the embodiment is preferably applicable to an electrical power supply unit (PSU).

Within the embodiment, the cross-sectional area through which electric current passes can be substantially increased when the header is electrically connected with the receptacle. Therefore, the resistance caused in applying electric current is reduced to thereby restrict the temperature increment. Further, according to the above described method of manufacturing the header, the process of fitting the first contact into the first insulator of the header and fixing the first contact to the first insulator of the header can be further facilitated and becomes more efficient.

All examples and conditional language recited herein are intended for pedagogical purposes to aid the reader in understanding the embodiments and the concepts contributed by the inventor to furthering the art, and are to be construed as being without limitation to such specifically recited examples and conditions, nor does the organization of such examples in the specification relate to a showing of superiority or inferiority of the embodiments. Although the connector has been described in detail, it should be understood that the various changes, substitutions, and alterations could be made hereto without departing from the spirit and scope of the invention.

What is claimed is:

1. A header connectable to a receptacle, the header comprising:
a first contact including a pair of first plate portions which are electrically conductive and are separated by an interval;
a plate-like conductive member which is accommodated between the pair of first plate portions;
a protrusion, which is formed in one of the first plate portions and the plate-like conductive member; and
a recess, which corresponds to the protrusion and is formed in another one of the first plate portions and the plate-like conductive member,
wherein the protrusion fits into the recess.
